(19) United States
(12) Patent Application Publication
(10) Pub. No.: US 2026/0266371 A1
(43) Pub. Date: Sep. 10, 2026

(54) SEAL GAS EMISSIONS FROM DRY GAS SEALS

(71) Applicant: AES Engineering Ltd., Rotherham (GB)

(72) Inventors: Christopher Carmody, Rotherham (GB); Christopher Rea, Rotherham (GB)

(73) Assignee: AES Engineering Ltd., Rotherham (GB)

(21) Appl. No.: 19/729,034

(22) Filed: Feb. 11, 2026

(30) Foreign Application Priority Data
Feb. 11, 2025 (GB) 2502016.5

(51) Int. Cl. F16J 15/00; F16J 15/40

(52) U.S. Cl. CPC F16J 15/006; F16J 15/406

(57) ABSTRACT

A gas recycling system, for use with a gas compressor having an inlet for gas at a relatively low pressure and an outlet for gas at a relatively high pressure, a gas-lubricated, non-contacting mechanical seal to which relatively high pressure may be fed from the gas compressor, the system including both a seal gas booster and a vent recycle system, the system further including means for feeding seal gas from the gas compressor to a conditioning system and from the conditioning system to the mechanical seal and an activation device to activate the gas booster once the gas difference exceeds a pre-determined level.

### BACKGROUND OF THE INVENTION

### Technical Field of Invention

The present invention relates, generally, to centrifugal compressors and other similar rotating equipment and, more particularly to systems for controlling the emissions of gases from dry gas seals used with such equipment.

### Description of the Prior Art

Centrifugal compressors and other similar rotating equipment are used to transport gases from one place to another or through process systems containing gases. These devices utilize rotating shafts containing impeller devices (or similar) which, due to their motion, impart energy into the gas thereby raising the gas pressure. In order to sustain the pressure, the rotor has to be housed in a pressurized casing where some sort of sealing device is required at the point of entry/exit where the rotary shaft passes through the casing. A consequence of the speed and pressure that the rotor, and hence the seals, are subject to is that a fluid is necessary in order to lubricate the interface between rotating and stationary components within the seal arrangement. In situations where dry gas seals (DGS) are used for sealing purposes, gas is used as the primary means of lubrication. In common with all forms of lubrication, there is a requirement that lubrication fluid is conditioned to be clean. However, in the case of a DGS, the lubrication gas must also be kept dry at all times. The necessity for conditioned seal gas is largely because the lubrication film supports the entire sealing loads even though the film is only a few microns thick. In situations where the lubrication gas film becomes contaminated, the operation and reliability of the DGS is compromised.

When the compressor is in operation, gas can be tapped off from a high pressure region of the compressor through a conditioning system where it is cleaned and dried before entering into the seal cavity. Once inside the seal cavity, some of the seal gas is used for lubricating the DGS faces, while the remaining gas flows back into the compressor through a restrictive device. The flow through the restrictive device ensures that unconditioned gas contained downstream within the compressor cannot enter the seal cavity thus ensuring that there is no contamination of the conditioned lubrication gas.

The lubrication gas, which flows though the sealing interface, is usually referred to as leakage where it emerges from the seal assembly into a vent system, where it is either flared or emitted directly to atmosphere. Irrespective of how the vent gases are removed, they are not only wasteful but also damaging to the environment. DGS seal leakage produces small amounts of damaging gas being released to atmosphere at all times so, even though the amounts are small, the cumulative effect of constant leakages adds up to a large amount of gas being emitted to atmosphere over a given period.

When the compressor is taken offline, the shaft rotation ceases thus disabling its pressure generating ability. The lack of pressure also dictates that gas no longer flows through the conditioning system and therefore clean and dry lubricating gas no longer flows into the seal cavity. Despite the compressor being offline, the seals will still leak statically due to the gas pressure within the compressor. The gas leaking across the seal faces will dictate that a small amount of gas will leave the seal cavity where the leaked gas is then replaced. A further consequence of the lack of conditioned gas flowing through the seal cavity is that unconditioned gas reverse flows from the compressor through the restrictive device thus contamination is present in the seal cavity. A further issue relating to the compressor being taken offline is that the compressor and its contents begin to cool due to energy no longer being imparted into the process gas. As the gas cools it becomes increasing wet as it nears vapor conditions where again it has an adverse effect on the seal gas. In the absence of having a means of preventing gas contamination when a compressor is offline, most operators elect to allow the gas to discharge from the compressor thus discharging its contents to atmosphere either directly or via a flare arrangement. This process is commonly referred to as a blowdown, an event which produces large amounts of damaging gas being released to atmosphere over a short period of time.

The associated issues are twofold:
1) DGS gas leakage being emitted through the vent system when gas is contained within the compressor; and,
2) Evacuating process gas (blowdown) when the compressor is offline.

### SUMMARY OF THE INVENTION

According to the present invention, there is provided a gas recycling system for use with a gas compressor having an inlet for gas at a relatively low pressure and an outlet for gas at a relatively high pressure, a gas-lubricated, non-contacting mechanical seal to which relatively high pressure gas may be fed from the compressor, the system comprising both a seal gas booster and a vent recycle system, the system further comprising means for feeding seal gas from the compressor to a conditioning system and from said conditioning system to said mechanical seal and means being provided to activate the gas booster one the gas difference exceeds a pre-determined level.

The prevention of DGS gas leakage can be achieved by firstly collecting the leaked gas after it emerges from the DGS and then utilizing a booster device so that the gas can be re-injected back into a low-pressure section of the compressor. Collecting and recycling the gas leakage in the manner prevents atmospheric emissions and flaring.

Blowdown prevention can be prevented by introducing a booster device in the seal gas supply system such that flow is generated when the compressor is offline so that conditioned gas is supplied to the seal cavity at all times. The supply of conditioned gas dictates that there will be no contamination of the DGS's. Atmospheric emissions during blowdowns are therefore prevented.

Accordingly, the present invention provides a system in which the booster operates in vent recycling mode during normal operation and primarily as a seal gas booster when the compressor is offline. The system prevents fugitive emissions being exhausted to atmosphere or flare systems which damage the environment.

Preferably, the system further comprises a collection vessel and means for feeding vent gas leaked from the mechanical seal into said collection vessel. More preferably, the system comprises means for feeding the vent gas from the collection vessel to the compressor via said inlet for gas.

Preferably, means are provided to cause the booster, while the compressor is not operating, to feed the seal gas through the conditioning system. More preferably, means are provided to monitor the pressure difference between the compressor inlet and outlet and for activating the gas booster when the pressure difference falls below a predetermined level.

Preferably, means are provided to monitor the pressure in the collection vessel and for activating the booster when the pressure increases above a predetermined level.

The present invention also provides a method for recycling gas leaking from a gas-lubricated, non-contacting mechanical seal, the method comprising the step of subjecting the leaked gas to the action of a gas recycling system of the present invention.

Other objects and features of the present invention will become apparent when considered in combination with the accompanying drawing figures, which illustrate certain preferred embodiments of the present invention. It should, however, be noted that the accompanying drawing figures are intended to illustrate only select preferred embodiments of the claimed invention and are not intended as a means for defining the limits and scope of the invention.

### BRIEF DESCRIPTION OF THE DRAWING FIGURES

The accompanying drawing figures will illustrate preferred embodiments of the present invention and are as follows:

FIG. 1 is a diagram of a compressor system of the invention shown in normal operation; and,

FIG. 2 shows the compressor system of FIG. 1 in offline operation.

### DETAILED DESCRIPTION OF THE DRAWING FIGURES AND PREFERRED EMBODIMENTS

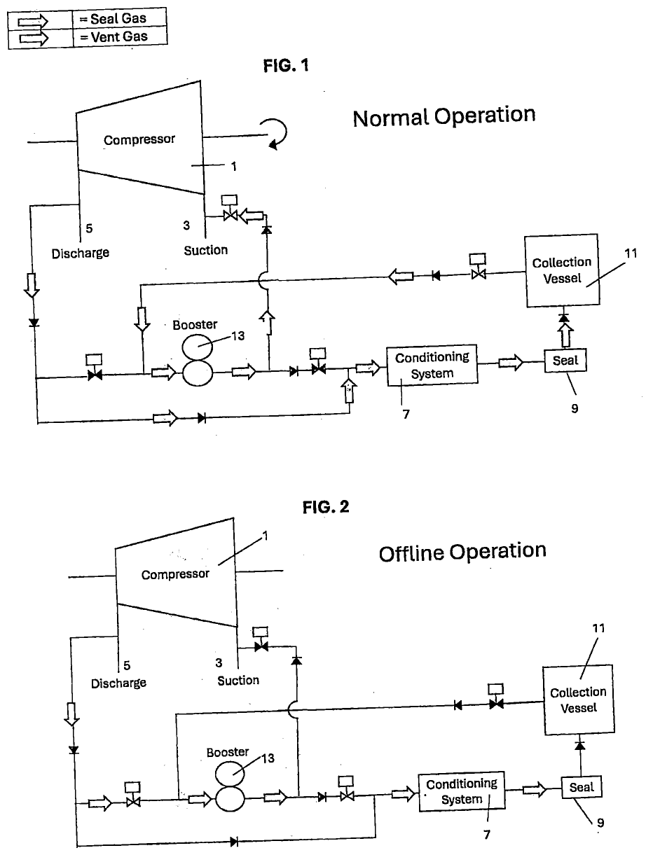

Normal Operation—Referring to FIG. 1 of the accompanying drawings, the process gas pressure is increased as it passes through the compressor 1 from the compressor inlet (suction) 3 to discharge outlet 5. At the high-pressure discharge end 5 of the compressor some gas is taken and routed through a conditioning system 7, which is used as the seal gas for the compressor dry gas seals 9 fitted to the compressor. The seal gas has to be conditioned so that the DGS does not get contaminated and subsequent failure occurs. Since the compressor is operational, there is sufficient seal gas pressure for it to flow through the conditioning system without the need for a booster. So, during normal operation the seal gas flows through a bypass line and not through the booster. The seal gas inlet and outlet valves are closed during normal operation. The conditioned seal gas then enters the seal cavity where some of the seal gas leaks through the faces and into a vent. The vent gas is then collected in collection vessel 11 and fed into the booster 13, which then allows the vent gas to flow back to the compressor suction. The vent gas inlet and outlet valves are open during normal operation.

Offline Operation—During offline operation the compressor 1 does not generate pressure and therefore the seal gas cannot flow through the conditioning system. This necessitates the need for a booster 13 to provide sufficient flow of seal gas through the conditioning system. During offline operation, the booster seal gas inlet and outlet valves are opened and the corresponding vent gas inlet and outlet valves are closed.

The pressure difference between the compressor suction and discharge is monitored. In general terms, the pressure difference (or head generated) increases with speed and duration of operation. When the pressure difference falls to around 0.5 bar, the compressor is considered to be offline. At this point a signal will be sent which starts the seal gas booster and once the compressor is back in service (i.e. the pressure difference goes above 0.5 bar) a further signal is produced which will stop the seal gas booster.

The vent collection vessel pressure is normally monitored by a pressure transmitter. When the pressure increases to a predetermined pressure a signal is sent to start the booster which will cause gas to flow out of the vessel and the pressure to fall. When the pressure reduces to a predetermined pressure a further signal is sent to stop the booster.

The logic adopted in both the above can also be used to open/close valves on the inlet and outlet pipework such that seal gas or vent gas recycling flows can be selected.

While only several embodiments of the present invention have been shown and described, it will be obvious to those skilled in the art that many modifications may be made to the present invention without departing from the spirit and scope thereof.

What is claimed is:

1. A gas recycling system for use with a gas compressor having an inlet for gas at a low pressure and an outlet for gas at a high pressure, a gas-lubricated, non-contacting mechanical seal to which high pressure is able to be fed from the gas compressor, said gas recycling system comprising both a seal gas booster and a vent recycle system, said gas recycling system further comprising means for feeding seal gas from the gas compressor to a conditioning system and from said conditioning system to said mechanical seal, and means for activating the seal gas booster once a gas difference exceeds a pre-determined level.

2. The gas recycling system according to claim 1, further comprising a collection vessel and means for feeding vent gas leaked from the mechanical seal into said collection vessel.

3. The gas recycling system according to claim 2, further comprising means for feeding the vent gas from said collection vessel to the gas compressor via said inlet for seal gas.

4. The gas recycling system according to claim 3, further comprising means to cause a gas booster, while the gas compressor is not operating, for feeding the seal gas through said conditioning system.

5. The gas recycling system according to claim 2, further comprising means to cause a gas booster, while the gas compressor is not operating, for feeding the seal gas through said conditioning system.

6. The gas recycling system according to claim 5, further comprising means for monitoring a pressure difference the inlet and outlet of the gas compressor for the gas booster when the pressure difference falls below a predetermined level.

7. The gas recycling system according to claim 6, further comprising means for monitoring pressure in said collection vessel and for activating the gas booster when the pressure increases above a predetermined level.

8. The gas recycling system according to claim 2, further comprising means for monitoring pressure in said collection vessel and for activating the gas booster when the pressure increases above a predetermined level.

9. A method for recycling gas leaking from a gas-lubricated, non-contacting mechanical seal, comprising the step of subjecting the gas leaking to a gas recycling system for use with a gas compressor having an inlet for gas at a low pressure and an outlet for gas at a high pressure, a gas-lubricated, non-contacting mechanical seal to which high pressure is able to be fed from the gas compressor, said gas recycling system comprising both a seal gas booster and a vent recycle system, said gas recycling system further comprising means for feeding seal gas from the gas compressor to a conditioning system and from said conditioning system to said mechanical seal, and means for activating the seal gas booster once a gas difference exceeds a pre-determined level.

10. The method for recycling gas leaking from a gas-lubricated, non-contacting mechanical seal according to claim 9, wherein said gas recycling system further comprising a collection vessel and means for feeding vent gas leaked from the mechanical seal into said collection vessel.

11. The method for recycling gas leaking from a gas-lubricated, non-contacting mechanical seal according to claim 10, wherein said gas recycling system further comprising means to cause a gas booster, while the gas compressor is not operating, for feeding the seal gas through said conditioning system.

12. The method for recycling gas leaking from a gas-lubricated, non-contacting mechanical seal according to claim 11, further comprising means for monitoring a pressure difference the inlet and outlet of the gas compressor for the gas booster when the pressure difference falls below a predetermined level.

13. The method for recycling gas leaking from a gas-lubricated, non-contacting mechanical seal according to claim 10, further comprising means for monitoring pressure in said collection vessel and for activating the gas booster when the pressure increases above a predetermined level.
